(19) United States
(12) Patent Application Publication
(10) Pub. No.: US 2021/0383371 A1
(43) Pub. Date: Dec. 9, 2021

(54) METHOD OF RECORDING TRANSACTIONS BASED ON BLOCKCHAIN AND ELECTRONIC DEVICE USING THE SAME

(71) Applicant: HON HAI PRECISION INDUSTRY CO., LTD., New Taipei (TW)

(72) Inventor: LIANG-TE CHIU, New Taipei (TW)

(21) Appl. No.: 17/335,346

(22) Filed: Jun. 1, 2021

(30) Foreign Application Priority Data
Jun. 5, 2020 (CN) 202010504776.2

(51) Int. Cl. G06Q 20/38; G06F 16/23

(52) U.S. Cl. CPC G06Q 20/389; G06F 16/2379

(57) ABSTRACT

A method of recording transactions of recording trades based on blockchain and implemented in a server causes the server to receive transactions sent by a terminal device, and extract a transaction category, an associated account number, and a transaction status from the transactions. When the transaction is a currency transfer, the server accesses a trading pool and/or a blockchain through a chain node. When target transactions are filtered out from the trading pool and/or the blockchain, the server calculates results of the target transactions and determines whether the transactions are correct, marks the transaction status of correct transactions as a pending chain status, and sends the marked transactions to the terminal device for confirmation. When receiving transaction information as to a successful transaction, the server marks the transaction status of the transactions as confirmed status, packages the transactions into blocks, and transmits the blocks to the blockchain.

### CROSS-REFERENCE TO RELATED APPLICATIONS

This application claims priority to Chinese Patent Application No. 202010504776.2 filed on Jun. 5, 2020, the contents of which are incorporated by reference herein.

### FIELD

The subject matter herein generally relates to recording by blockchain, especially to a method of recording transactions based on blockchain and an electronic device using the same.

### BACKGROUND

Bitcoin in 2009 has accelerated blockchain technology. However, existing blockchain technology does not meet the number of transactions per second preferred for commercial-grade transactions, i.e. 30 million transactions per second. The processing of blockchain protocols need to be more efficient.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a method of recording transactions based on blockchain.

FIG. 2 is a block diagram of an embodiment of a running environment of the method of recording transactions of FIG. 1.

FIG. 3 is a block diagram of an embodiment of a trading system based on blockchain.

FIG. 4 is a block diagram of an embodiment of an electronic device for the environment of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

A method of recording transactions for recording data of financial transactions based on blockchain is applied in an electronic device. The electronic device can include, but is not limited to, a microprocessor, an Application Specific Integrated Circuit, a Field-Programmable Gate Array, a Signal Digital Processor, embedded devices, and the like, and software to enable function.

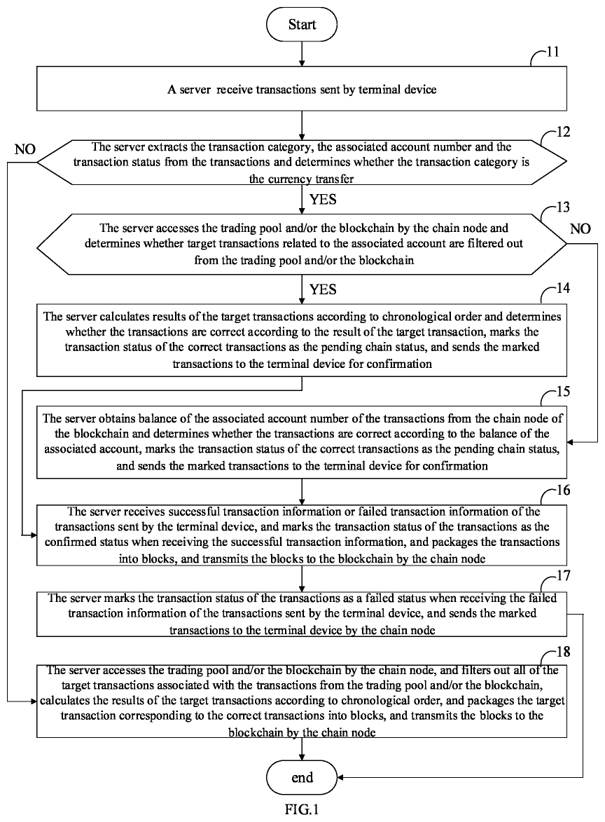

FIG. 1 illustrates a flowchart of the method of recording transactions based on blockchain. The method is provided by way of example, as there are a variety of ways to carry out the method. Each block shown in FIG. 1 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 11.

At block 11, a server 2 receives transactions sent by terminal device 1, where each transaction includes a transaction category, an associated account number, and a transaction status.

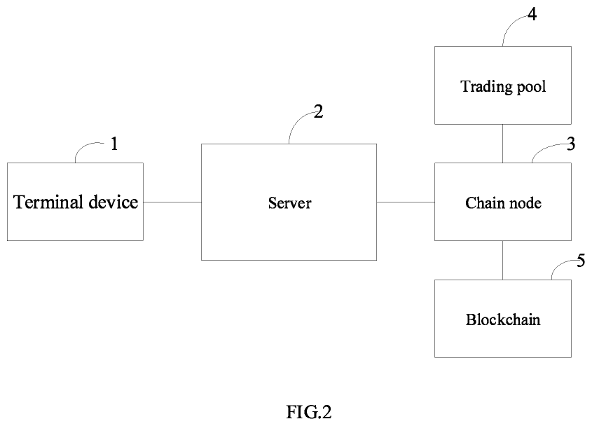

FIG. 2 illustrates a running environment of the method of recording transactions. The method of recording transactions is applied in the server 2 and in a chain node 3. In one embodiment, the server 2 and the chain node 3 are two different devices, and the server 2 connects to the chain node 3. In another embodiment, the server 2 and the chain node 3 are the same device. In one embodiment, the server 2 communicates with the terminal device 1, and the server 2 receives the transactions sent by the terminal device 1. In one embodiment, the server 2 communicates with several terminal devices 1, and receives data of transactions sent by each of the terminal devices 1. In one embodiment, the number of servers 2 can be many, according to a business volume demand. The chain node 3 can exchange data with a transaction pool 4 and a blockchain 5. In one embodiment, the number of chain nodes 3 can be many, the server 2 can access the transaction pool 4 and the blockchain 5 through any chain node 3. In one embodiment, a number of transactions are stored in the transaction pool 4 and the blockchain 5. In one embodiment, the server 2 communicates with the chain node 3 by a 4G/5G network, the terminal device 1 communicates with the server 2 by the 4G/5G network, and the chain node 3 communicates with the blockchain 5 by the 4G/5G network.

In one embodiment, the terminal device 1 encapsulates the transaction and sends the encapsulated transaction to the server 2. In one embodiment, each transaction includes a transaction number, a transaction status, a transaction category, an associated account number, a transaction content, and an inspection code. In one embodiment, the transaction number serializes and identifies the transaction. The transaction number can consist of letters and numbers, for example, the transaction number may be expressed as “Tx4939”. The transaction status indicates the status of the transaction. In one embodiment, the transaction status includes a released status, a pending chain status, a confirmed status, and a failed status. The transaction category is used to indicate a type of transaction. In one embodiment, the transaction category includes a currency transfer and a transaction record. In one embodiment, the associated account number is associated with the transaction, for example, the associated account number may be expressed as “User account A” and “User account B”. The inspection code is used to inspect the transaction. In one embodiment, the inspection code is a hash value. In one embodiment, when the terminal device 1 sends the transaction to the server 2, the status of the transactions is the released status.

At block 12, the server 2 extracts the transaction category, the associated account number, and the transaction status from the transactions and determines whether the transaction category of each transaction is the currency transfer. In one embodiment, when the transaction category is the currency transfer, block 13 is executed, and when the transaction category is the transaction record, block 18 is executed.

At block 13, the server 2 accesses the trading pool 4 and/or the blockchain 5 by the chain node 3 and determines whether target transactions related to the associated account are filtered out from the trading pool 4 and/or the blockchain 5. In one embodiment, when the target transactions related to the associated account are filtered out from the trading pool 4 and/or the blockchain 5, block 14 is executed. When the target transactions related to the associated account are not filtered out from the trading pool 4 and/or the blockchain 5, block 15 is executed.

At block 14, the server 2 calculates results of the target transactions according to chronological order and determines whether the transactions are correct according to the result of the target transaction, marks the transaction status of the correct transactions as the pending chain status, and sends the marked transactions to the terminal device 1 for confirmation. In one embodiment, after block 14, block 16 is executed.

For example, when the associated account numbers of the transactions relate to user account A and user account B, the server 2 accesses the trading pool 4 and/or the blockchain 5 by the chain node 3, and filters out the target transactions related to the user account A and user account B. The results of the target transactions in sequence according to the chronological order are calculated, and the correctness of the transactions is determined, marks the transaction status of the correct transactions as pending chain status, and sends the marked transactions to the terminal device 1 for confirmation.

In one embodiment, the server 2 calculates the content of the target transactions according to chronological order, determines that the transactions are correct when the content of the target transactions is consistent, and determines that the transactions are incorrect when the content of the transactions is inconsistent.

At block 15, the server 2 obtains balance of the associated account number of the transactions from the chain node 3 of the blockchain 5 and determines whether the transactions are correct according to the balance of the associated account. The transaction status of the correct transactions is marked as the pending chain status, and the marked transactions are sent to the terminal device 1 for confirmation. In one embodiment, after block 15, block 16 is executed.

In one embodiment, when the balance of a transferred account in the associated account of the transactions is not less than a transfer amount, the transactions are deemed correct; when the balance of the transferred account in the associated account of the transactions is less than the transfer amount, the transactions are deemed incorrect.

At block 16, the server 2 receives successful transaction information or failed transaction information of the transactions sent by the terminal device 1, and marks the transaction status of the transactions as the confirmed status when receiving the successful transaction information, and packages the transactions into blocks, and transmits the blocks to the blockchain 5 by the chain node 3.

In one embodiment, the server 2 transmits the transactions with the pending chain status to the transaction pool 4 by the chain node 3, obtains the transactions with the pending chain status from the trading pool 4 by the chain node 3 when receiving the successful transaction information of the transactions sent by the terminal device 1, and packages the transactions into the blocks, and transmits the blocks the blockchain 5 by the chain node 3.

At block 17, the server 2 marks the transaction status of the transactions as a failed status when receiving the failed transaction information of the transactions sent by the terminal device 1, and sends the marked transactions to the terminal device 1 by the chain node 3.

At block 18, the server 2 accesses the trading pool 4 and/or the blockchain 5 by the chain node 3, and filters out all of the target transactions associated with the transactions from the trading pool 4 and/or the blockchain 5. The results of the target transactions are calculated according to chronological order, and the target transactions corresponding to correct transactions are packaged into blocks, and transmitted to the blockchain 5 by the chain node 3.

In one embodiment, the method of recording transactions further includes the server 2 marking the status of incorrect transactions as failed status, and transmitting the incorrect transactions with failed status to the terminal device 1. The terminal device 1 is notified to delete the incorrect transactions.

In one embodiment, the server 2 filters out the target transactions related to the associated account number of the transactions from the trading pool 4 and the blockchain 5, and determines that the transactions are correct when calculation results of the target transactions are correct. When the target transactions related to the related account of the transaction are not filtered out from the trading pool 4 and the blockchain 5, the server 2 determines whether the transactions are correct according to the balances of the associated account of the transactions. When the transactions are correct and the server 2 receives the successful transaction information of the transactions sent by the terminal device, the server 2 packages the transactions into blocks, and transmits the blocks to the blockchain 5 by chain node 3, thereby improving processing efficiency of the blockchains and meeting commercial requirements for the processable number of transactions of the blockchain.

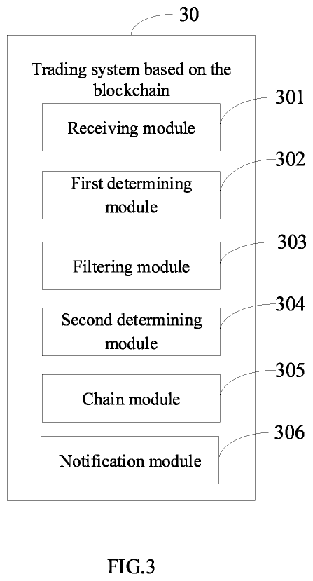

FIG. 3 illustrates a trading system 30 based on the blockchain. The trading system 30 is applied in the server 2. In one embodiment, according to the functions it performs, the trading system 30 can be divided into a plurality of functional modules. The functional modules perform the blocks 11-18 in the embodiment of FIG. 1 to perform the functions of trading based on the blockchain. The trading system 30 includes, but is not limited to, a receiving module 301, a first determining module 302, a filtering module 303, a second determining module 304, a chain module 305, and a notification module 306. The modules 301-306 of the trading system 30 can be collections of software instructions. The modules in the present disclosure refers to a series of computer program segments which can be executed by at least one processor and can perform the functions of trading based on the blockchain, the modules being stored in memory.

The receiving module 301 receives transactions sent by terminal device 1, where each of the transactions includes transaction category, associated account number, and transaction status.

In one embodiment, the terminal device 1 encapsulates the transaction and sends the encapsulated transaction to the server 2. In one embodiment, each transaction includes a transaction number, a transaction status, a transaction category, an associated account number, a transaction content, an inspection code. In one embodiment, the transaction number is used to serialize and identify the transaction. The transaction number consists of letters and numbers, for example, the transaction number may be expressed as “Tx4939”. The transaction status is used to indicate the status of the transaction. In one embodiment, the transaction status includes a released status, a pending chain status, a confirmed status and a failed status. The transaction category is used to indicate a type of transaction. In one embodiment, the transaction category includes a currency transfer and a transaction record. In one embodiment, the associated account number is associated with the transaction, for example, the associated account number may be expressed as “User account A” and “User account B”. The inspection code is used to inspect the transaction. In one embodiment, the inspection code is a hash value. In one embodiment, when the terminal device 1 sends the transaction to the server 2, the status of the transaction is the released status.

The first determining module 302 extracts the transaction category, the associated account number, and the transaction status from the transactions and determines whether the transaction category is the currency transfer.

The filtering module 303 accesses the trading pool 4 and/or the blockchain 5 by the chain node 3 and determines whether target transactions related to the associated account are filtered out from the trading pool 4 and/or the blockchain 5.

The second determining module 304 calculates results of the target transactions according to chronological order and determines whether the transactions are correct according to the result of the target transaction, marks the transaction status of the correct transactions as the pending chain status, and sends the marked transactions to the terminal device 1 for confirmation.

For example, when the associated account numbers of the transactions are user account A and user account B, the second determining module 304 accesses the trading pool 4 and/or the blockchain 5 by the chain node 3, and filters out the target transactions related to the user account A and user account B, and calculates the results of the target transactions in sequence according to the chronological order, determines whether the transactions are correct according to the results of the target transaction, marks the transaction status of the correct transactions as pending chain status, and sends the marked transactions to the terminal device 1 for confirmation.

In one embodiment, the second determining module 304 calculates the content of the target transactions according to chronological order, determines that the transactions are correct when the content of the target transactions is consistent, and determines that the transactions are incorrect when the content of the transactions is inconsistent.

The second determining module 304 obtains balance of the associated account number of the transactions from the chain node 3 of the blockchain 5 and determines whether the transactions are correct according to the balance of the associated account, marks the transaction status of the correct transactions as the pending chain status, and sends the marked transactions to the terminal device 1 for confirmation.

In one embodiment, when the balance of a transferred account in the associated account of the transactions is not less than a transfer amount, the transactions are deemed correct; when the balance of the transferred account in the associated account of the transactions is less than the transfer amount, the transactions are deemed incorrect.

The chain module 305 receives successful transaction information or failed transaction information of the transactions sent by the terminal device 1, and marks the transaction status of the transactions as the confirmed status when receiving the successful transaction information, and packages the transactions into blocks, and transmits the blocks to the blockchain 5 by the chain node 3.

In one embodiment, the chain module 305 transmits the transactions with the pending chain status to the transaction pool 4 by the chain node 3, obtains the transactions with the pending chain status from the trading pool 4 by the chain node 3 when receiving the successful transaction information of the transactions sent by the terminal device 1, and packages the transactions into the blocks, and transmits the blocks the blockchain 5 by the chain node 3.

When the transaction category is the transaction record, the chain module 305 further accesses the trading pool 4 and/or the blockchain 5 by the chain node 3, and filters out all of the target transactions associated with the transactions from the trading pool 4 and/or the blockchain 5, calculates the results of the target transactions according to chronological order, and packages the target transaction corresponding to the correct transactions into blocks, and transmits the blocks to the blockchain 5 by the chain node 3.

The notification module 306 marks the transaction status of the transactions as failed status when receiving the transaction information as to failed sent by the terminal device 1, and sends the marked transactions to the terminal device 1 by the chain node 3.

In one embodiment, the notification module 306 further marks the status of transactions which are incorrect as failed, and transmits such transactions to the terminal device 1, and notifies the terminal device 1 to delete the incorrect transactions.

In one embodiment, when the transactions are correct and the server 2 receives the successful transaction information of the transactions sent by the terminal device, the server 2 packages the transactions into blocks, and transmits the blocks to the blockchain 5 by chain node 3, thereby improving processing efficiency of the blockchains and meeting the number of transactions of the blockchain in commerce.

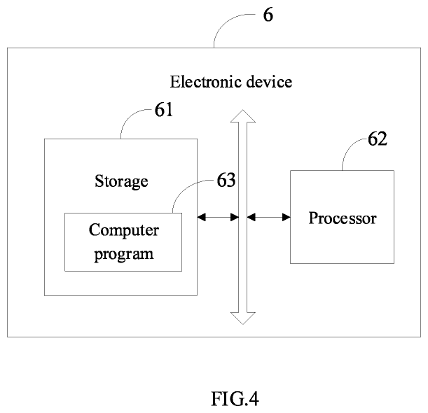

FIG. 4 illustrates the electronic device 6. The electronic device 6 includes a storage 61, a processor 62, and a computer program 63 stored in the storage 61 and executed by the processor 62. When the processor 62 executes the computer program 63, the blocks in the embodiment of the method of recording transactions based on blockchain are implemented, for example, blocks 11 to 18 as shown in FIG. 1. Alternatively, when the processor 62 executes the computer program 63, the functions of the modules in the embodiment of the trading system based on blockchain are implemented, for example, modules 301-306 shown in FIG. 3.

In one embodiment, the computer program 63 can be partitioned into one or more modules/units that are stored in the storage 61 and executed by the processor 62. The one or more modules/units may be a series of computer program instruction segments capable of performing a particular function, and the instruction segments describe the execution of the computer program 63 in the electronic device 6. For example, the computer program 63 can be divided into the receiving module 301, the first determining module 302, the filtering module 303, the second determining module 304, the chain module 305, and the notification module 306 as shown in FIG. 3.

FIG. 4 shows only one example of the electronic device 6. There are no limitations of the electronic device 6, and other examples may include more or less components than those illustrated, or some components may be combined, or have a different arrangement. The components, such as the electronic device 6, may also include input devices, output devices, communication unit, network access devices, buses, and the like. In one embodiment, the electronic device 6 and the server 2 are one and the same device.

The processor 62 can be a central processing unit (CPU), and also include other general-purpose processors, a digital signal processor (DSP), and application specific integrated circuit (ASIC), Field-Programmable Gate Array (FPGA) or other programmable logic device, discrete gate or transistor logic device, discrete hardware components, etc. The processor 62 may be a microprocessor or the processor may be any conventional processor or the like. The processor 62 is the control center of the electronic device 6, and connects the entire electronic device 6 by using various interfaces and lines.

The storage 61 stores data and programs of the electronic device 6. For example, the storage 61 can store the trading system 30 based on blockchain. In at least one exemplary embodiment, the storage 61 can include various types of non-transitory computer-readable storage mediums. For example, the storage 61 can be an internal storage system, such as a flash memory, a random access memory for temporary storage of information, and/or a read-only memory for permanent storage of information. The storage 61 can also be an external storage system, such as a hard disk, a storage card, or a data storage medium.

In one embodiment, the modules/units integrated in the electronic device 6 can be stored in a computer readable storage medium if such modules/units are implemented in the form of a purchased product. Thus, the present disclosure may be implemented and realized in any part of the method of the foregoing embodiments, or may be implemented by the computer program, which may be stored in the computer readable storage medium. The steps of the various method embodiments described above may be implemented by a computer program when executed by a processor. The computer program includes computer program code, which may be in the form of source code, object code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM), electrical carrier signals, telecommunication signals, and software distribution media.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A method of recording transactions based on blockchain comprising:
receiving transactions sent by a terminal device, wherein each of the transactions comprises a transaction category, an associated account number and a transaction status;
extracting the transaction category, the associated account number and the transaction status from the transactions and determining whether the transaction category is a currency transfer;
if the transaction category is the currency transfer, accessing a trading pool and/or a blockchain by a chain node and determining whether target transactions related to the associated account are filtered out from the trading pool and/or the blockchain, wherein
if the target transactions are filtered out from the trading pool and/or the blockchain, calculating results of the target transactions according to chronological order and determining whether the transactions are correct according to the result of the target transaction, marking the transaction status of correct transactions as a pending chain status, and sending the marked transactions to the terminal device for confirmation; and
after receiving successful transaction information of the transactions, marking the transaction status of the transactions as a confirmed status, and packaging the transactions into blocks, and transmitting the blocks to the blockchain by the chain node.

2. The method of recording transactions based on blockchain according to claim 1, further comprising:
if the transaction category is the transaction record, accessing the trading pool and/or the blockchain by the chain node, and filtering out all of the target transactions associated with the transactions from the trading pool and/or the blockchain, calculating the results of the target transactions according to chronological order, and packaging the target transaction corresponding to the correct transactions into blocks, and transmitting the blocks to the blockchain by the chain node.

3. The method of recording transactions based on blockchain according to claim 1, further comprising:
if the target transactions related to the associated account are not filtered out from the trading pool and/or the blockchain, obtaining balance of the associated account number of the transactions from the chain node of the blockchain and determining whether the transactions are correct according to the balance of the associated account, marking the transaction status of the correct transactions as the pending chain status, and sending the marked transactions to the terminal device for confirmation.

4. The method of recording transactions based on blockchain according to claim 1, further comprising:
after receiving the failed transaction information of the transactions sent by the terminal device, marking the transaction status of the transactions as a failed status, and sending the marked transactions to the terminal device by the chain node.

5. The method of recording transactions based on blockchain according to claim 1, further comprising:
calculating content of the target transactions according to chronological order;
determining that the transactions are correct when the content of the target transactions is consistent, and
determining that the transactions are incorrect when the content of the transactions is inconsistent.

6. The method of recording transactions based on blockchain according to claim 1, further comprising:
transmitting the transactions with the pending chain status to the transaction pool by the chain nod, obtaining the transactions with the pending chain status from the trading pool by the chain node when receiving the successful transaction information of the transactions sent by the terminal device, and packaging the transactions into the blocks, and transmitting the blocks the blockchain by the chain node.

7. The method of recording transactions based on blockchain according to claim 1, further comprising:
marking the status of incorrect transactions as the failed status, and transmitting the incorrect transactions with the failed status to the terminal device, and notifying the terminal device to delete the incorrect transactions.

8. The method of recording transactions based on blockchain according to claim 3, wherein if the balance of a transferred account in the associated account of the transactions is not less than a transfer amount, the transactions are correct; and if the balance of the transferred account in the associated account of the transactions is less than the transfer amount, the transactions are incorrect.

9. An electronic device comprising:
a processor;
a non-transitory storage medium coupled to the processor and configured to store a plurality of instructions, which causes the processor to:
receive transactions sent by a terminal device, wherein each of the transactions comprises a transaction category, an associated account number and a transaction status;
extract the transaction category, the associated account number and the transaction status from the transactions and determine whether the transaction category is the currency transfer;
if the transaction category is the currency transfer, access a trading pool and/or a blockchain by a chain node and determine whether target transactions related to the associated account are filtered out from the trading pool and/or the blockchain, wherein
if the target transactions are filtered out from the trading pool and/or the blockchain, calculate results of the target transactions according to chronological order and determine whether the transactions are correct according to the result of the target transaction, mark the transaction status of correct transactions as a pending chain status, and send the marked transactions to the terminal device for confirmation; and
after receiving the successful transaction information of the transitions, mark the transaction status of the transactions as a confirmed status, and package the transactions into blocks, and transmit the blocks to the blockchain by the chain node.

10. The electronic device according to claim 9, wherein the plurality of instructions is further configured to cause the processor to:
if the transaction category is the transaction record, accessing the trading pool and/or the blockchain by the chain node, and filtering out all of the target transactions associated with the transactions from the trading pool and/or the blockchain, calculating the results of the target transactions according to chronological order, and packaging the target transaction corresponding to the correct transactions into blocks, and transmitting the blocks to the blockchain by the chain node.

11. The electronic device according to claim 9, wherein the plurality of instructions is further configured to cause the processor to:
if the target transactions related to the associated account are not filtered out from the trading pool and/or the blockchain, obtain balance of the associated account number of the transactions from the chain node of the blockchain and determine whether the transactions are correct according to the balance of the associated account, mark the transaction status of the correct transactions as the pending chain status, and send the marked transactions to the terminal device for confirmation.

12. The electronic device according to claim 9, wherein the plurality of instructions is further configured to cause the processor to:
after receiving the failed transaction information of the transactions sent by the terminal device, mark the transaction status of the transactions as a failed status, and send the marked transactions to the terminal device by the chain node.

13. The electronic device according to claim 9, wherein the plurality of instructions is further configured to cause the processor to:
calculate content of the target transactions according to chronological order;
determine that the transactions are correct when the content of the target transactions is consistent, and
determine that the transactions are incorrect when the content of the transactions is inconsistent.

14. The electronic device according to claim 9, wherein the plurality of instructions is further configured to cause the processor to:
transmit the transactions with the pending chain status to the transaction pool by the chain nod, obtain the transactions with the pending chain status from the trading pool by the chain node when receiving the successful transaction information of the transactions sent by the terminal device, and package the transactions into the blocks, and transmit the blocks the blockchain by the chain node.

15. The electronic device according to claim 9, wherein the plurality of instructions is further configured to cause the processor to:
mark the status of incorrect transactions as the failed status, and transmit the incorrect transactions with failed status to the terminal device, and notify the terminal device to delete the incorrect transactions.

16. The electronic device according to claim 9, wherein if the balance of a transferred account in the associated account of the transactions is not less than a transfer amount, the transactions are correct; and if the balance of the transferred account in the associated account of the transactions is less than the transfer amount, the transactions are incorrect.
